(19) United States
(12) Patent Application Publication
(10) Pub. No.: US 2022/0069446 A1
(43) Pub. Date: Mar. 3, 2022

(54) SAR Reduction Method for LTE and 5G Antenna put at System of Laptop and Convertible Laptop

(71) Applicant: Hewlett-Packard Development Company, L.P., Spring, TX (US)

(72) Inventors: Chien-pai Lai, Taipei City (TW); Chin Hung Ma, Taipei City (TW); Shih Huang Wu, Spring, TX (US); Isaac Lagnado, Spring, TX (US)

(73) Assignee: Hewlett-Packard Development Company, L.P., Spring, TX (US)

(21) Appl. No.: 17/296,431

(22) PCT Filed: May 13, 2019
(86) PCT No.: PCT/US2019/031949

§ 371 Date: May 24, 2021

(51) Int. Cl. H01Q 1/24; H01Q 9/42

(52) U.S. Cl. CPC H01Q 1/245; H01Q 9/42

(57) ABSTRACT

The present subject matter relates to examples of an antenna assembly that may include a SAR correction element. The antenna assembly may include a radiation body that can have transceiver portion and non-transceiver portion, such that the transceiver portion may send and receive a wireless signal. In one example, the SAR correction element may be electrically coupled between the non-transceiver portion and a ground plane in order to dissipate energy from the non-transceiver portion to the ground in way that the SAR correction element does not accumulate energy therein while dissipating the energy to the ground.

### BACKGROUND

In recent years, consumer electronic devices find ubiquitous use for various purposes, including communication, consumption of entertainment media, and gaming. Such consumer electronic devices can include, for example, electronic book readers, cellular phones, personal digital assistants (PDAs), portable media players, tablet computers, and laptop computers. All such consumer electronic devices, generally, are capable of operating wirelessly for transmission and reception of digital data and, accordingly, all such electronic devices are provided with an antenna for the purpose of communicating wirelessly. In turn, every antenna has an associated specific absorption rate (SAR) value. SAR value is a measure of the rate at which energy is absorbed by a body, i.e., the human body, when exposed to a radio frequency (RF) electromagnetic field generated due to transmission by that antenna.

### BRIEF DESCRIPTION OF DRAWINGS

The detailed description is provided with reference to the accompanying figures, wherein:

FIG. 1 illustrates a user equipment including an antenna assembly, according to an example;

FIG. 2 illustrates a schematic of an antenna assembly, according to an example;

FIG. 3 illustrates a detailed schematic of the antenna assembly, according to an example;

FIG. 4 illustrates an antenna assembly, according to one example; and

FIG. 5 illustrates an antenna assembly, according to another example

### DETAILED DESCRIPTION

As an effort to protect the users from the adverse effects of RE electromagnetic fields on the human body, a certain standard SAR value or a range thereof has been defined resulting in a focus on controlling the SAR values of antennas during transmission. Generally, the SAR value is controlled by regulating a distance between the antenna and the user's body. Recently, with rising demand of compact consumer electronic devices, a space available inside the consumer electronic devices has reduced. As a result, the distance between the user's body and the antenna has reduced thereby increasing a need for regulating the SAR value. One of the generally used technique to keep SAR value within a regulated value is by reducing a power output of the antenna. However, reducing the power of the antenna reduces performance and transmission range of the antenna.

Another generally used technique for keeping the SAR value within a regulated value may involve a modification in the antenna design to tune antenna impedance for reducing the SAR value associated with the antenna. However, in such techniques, radiation distribution or radiation pattern of the antenna may be adversely affected thereby impacting transmission. Certain other techniques may involve using one or more capacitor elements in the antenna circuit for tuning the antenna impedance. However, the permanent modification of the antenna circuitry by such techniques may yet again impact the antenna efficiency by affecting the shape of radiation pattern either during reception or transmission or both.

Examples of an antenna assembly for a user equipment are described. The antenna assembly based on the subject matter includes a SAR correction element that can dissipate energy, for instance, a near-field energy, present on a surface of an antenna to a ground plane without accumulating the energy while dissipating the energy, thereby reducing the SAR value associated with the antenna assembly. In addition, the SAR correction element may also facilitate in maintaining a resonance characteristic of the antenna such that the transmission range of the antenna is not affected.

According to an example, the antenna assembly may include a radiation body that may have a transceiver portion and non-transceiver portion, such that the transceiver portion may transmit and receive a wireless signal. Further, the SAR correction element of the antenna assembly may be coupled to the non-transceiver portion of the radiation body in such a way that the resonance characteristics of the radiation body is matched.

According to another example, the non-transceiver portion may further include a short end that can be used to couple the non-transceiver portion to the ground plane, such as a metal body of the user equipment. The non-transceiver portion may also include an open end that may be formed as an overhang of the non-transceiver portion with respect to the ground plane. Further, the radiation body may have a predefined resonance characteristic, i.e. a combination of inductive and capacitive characteristic in order to transmit and receive the wireless signal.

As mentioned previously, the antenna assembly may also include the SAR correction element. According to an aspect, the SAR correction element is a reactive integrated circuit (1C) that may be coupled to the non-transceiver portion. In an example, the antenna may include multiple reactive ICs, one connected to each of the open end and the short end. According to an example, the SAR correction element can be an inductive SAR correction element that can electrically couple the short end to the ground plane, such that the inductive SAR correction element may match the inductive characteristics of the radiation body. According to another example, the SAR correction element can be a capacitive SAR correction element that may electrically couple the open end to the ground plane, such that the capacitive SAR correction element may match the capacitive characteristics of the radiation body.

The SAR correction element dissipates the energy, such that the SAR value is reduced. Since the SAR value is reduced, the distance between the antenna and the user body can be reduced. As a result, the SAR correction elements allows for compact user devices while maintaining the SAR value within predefined range. Moreover, since the SAR correction element matches the resonance characteristics of the radiation body, the SAR correction element can achieve reduction in SAR value without adversely affecting the transmission range of the radiation body, and therefore, of the antenna. In another example, the transmission range of the radiation body may also be increased for better communication due to reduction in the SAR value.

The above aspects are further described in conjunction with the figures, and in associated description below. It should be noted that the description and figures merely illustrate principles of the present subject matter. Therefore, various assemblies that encompass the principles of the present subject matter, although not explicitly described or shown herein, may be devised from the description and are included within its scope. Additionally, the word “coupled” is used throughout for clarity of the description and can include either a direct connection or an indirect connection.

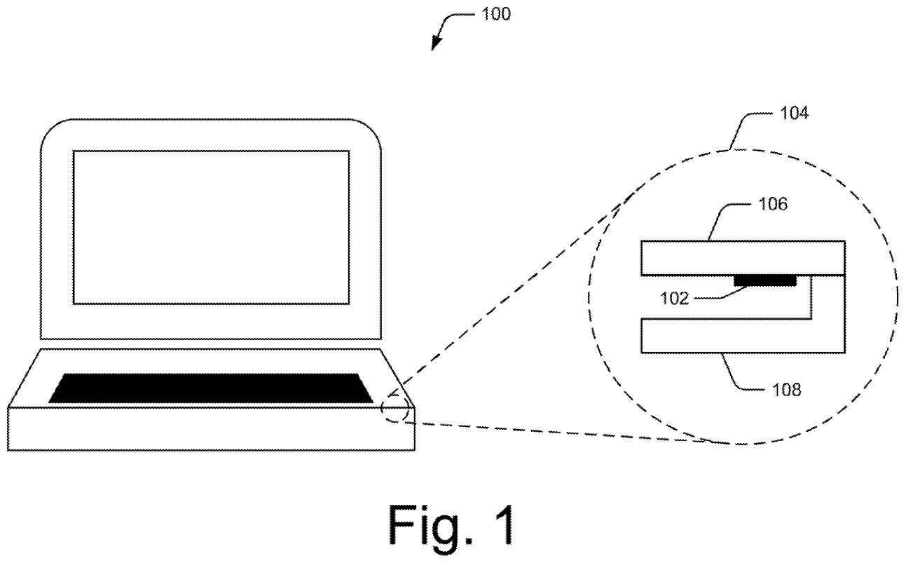

FIG. 1 illustrates a user equipment 100, according to an example of the present subject matter. As examples, the user equipment 100 can be a mobile phone, a laptop, a handheld PC. Further, the user equipment 100 can be capable of connecting to a wireless network, such as Wi-Fi or a cellular network. Furthermore, the user equipment 100 may include a wireless unit (not shown) that may allow the user equipment 100 to receive information over the wireless network. In one example, the user equipment 100 can include an antenna assembly 102 operably coupled to the wireless unit to facilitate transmission and reception of a wireless signal from and to the wireless unit. For instance, the antenna assembly 102 may be external to the wireless unit and may be coupled to the wireless unit by electronic connections, such as cables. In another instance, the antenna assembly 102 may be integrated to the wireless unit. In one example, the antenna assembly 102 may be installed within the housing of the user equipment 100. For instance, the antenna assembly 102 may be positioned at one of the corners of the user equipment 102. An example position of the antenna assembly 102 is shown in an enlarged section 104 of a corner of the antenna assembly 102.

As illustrated in the enlarged section 104, as an example, the antenna assembly 102 may be positioned within a body of the user equipment 100. For example, the body may include a top cover 106 and a bottom cover 108 of the user equipment 100. For instance, the antenna assembly 102 may be mounted to the top cover 106 inside the user equipment 100. The top cover, in one example, can be a top shell of the user equipment 100 that may house different user interfaces, such as a keyboard or a touchpad. In another example, the antenna assembly 102 may be mounted to the bottom cover 108 inside the user equipment 100. For instance, the bottom cover 108 can be a base of the user equipment 100 that may allow mounting of the circuitry, such as a motherboard and the wireless unit of the user equipment 100.

According to an example, the antenna assembly 102 may be configured in a way that a SAR value of the antenna assembly 102 does not exceed a predefined range. As a result, the SAR value of the antenna assembly 102 does not affects a user using the user equipment 100. In one example, the antenna assembly 102 may include a SAR correction element that may facilitate in reduction of the SAR value of the antenna assembly 102 to be substantially within the predefined SAR range. In an example, the predefined range of SAR value may be defined by different standards, such as Federal Communications Commission (FCC) standards or European Committee for Electrotechnical Standardization (CENELEC) standards.

The SAR correction element may dissipate an energy that may contribute to an increase in the SAR value of the antenna assembly 102 to a ground plane, such as the body of the user equipment 100. For instance, the ground plane can be the top cover 106 and, in another instance, the ground plane can be the bottom cover 108 of the user equipment 100. In either instance, the ground plane may be large enough to dissipate the energy to the environment. For instance, the energy can be a near-field energy may not be strong enough to allow transmission of wireless signal but may be strong enough to affect the user's body when the user is exposed to the near-field energy.

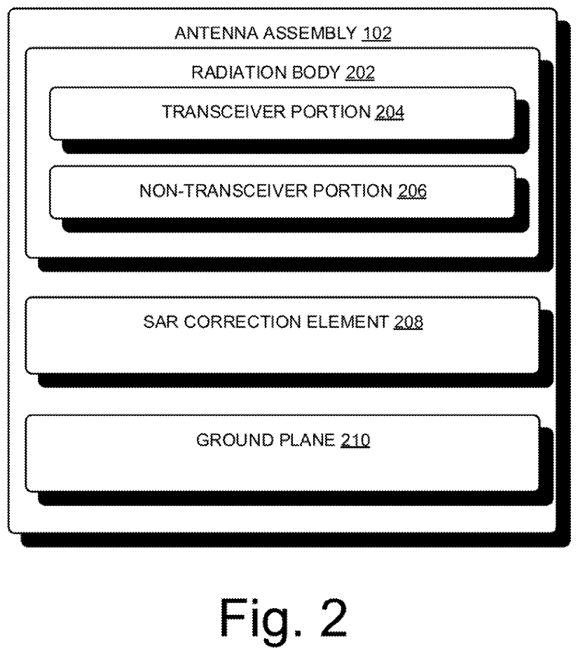

The SAR correction element is designed such that the SAR correction element does not accumulate the energy while dissipating the energy. Moreover, the SAR correction element is designed in such a way that the SAR correction element does not generate or radiate the energy while the antenna assembly 102 transmits or receives the wireless signal. For example, the SAR correction element may be a reactive integrated circuit (IC) that, in addition to dissipating energy without accumulating it, may match a resonance characteristic of antenna assembly 102, such that a transmission range of the antenna assembly remains unaffected by dissipation of energy. For instance, the SAR correction element can match an inductive characteristic of the antenna assembly 102 while in other instance, the SAR correction element may match a capacitive characteristic of the antenna assembly 102. In one example, the reactive IC can be made one of a multi-layer ceramic capacitor, a multi-layer inductor, a switch, or a diode. An example illustration of the antenna assembly 102 is explained with respect to FIG. 2.

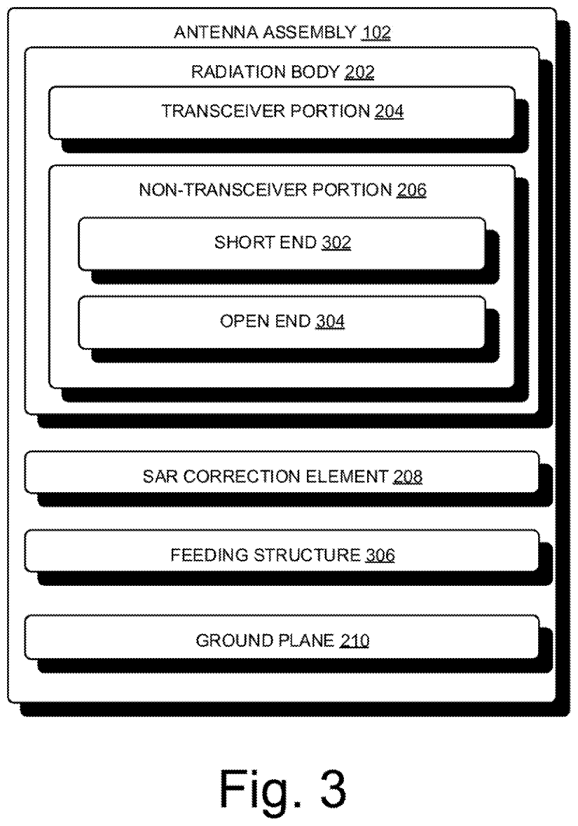

FIG. 2 illustrates a schematic of the antenna assembly 102, according to an example of the present subject matter. The antenna assembly 102 may include a radiation body 202 that may further include a transceiver portion 204 and a non-transceiver portion 206, such that the transceiver portion 204, in operation, may send and receive a wireless signal. In addition, the radiation body 202 may also include a non-transceiver portion 206 that may be coupled to the transceiver portion 204. The antenna assembly 102 may also include a SAR correction element 208 that may electrically couple the non-transceiver portion 206 to a ground plane 210. In an example, the ground plane 210 can be a large piece of metal. In another example, the ground plane 210 can be the top cover 106 or the bottom cover 108 of the user equipment 100. In one example, the SAR correction element 208 may dissipate energy from the non-transceiver portion 206 to the ground plane 210 in order to reduce the SAR value of the user equipment 100 in such a way that the SAR correction element 208 does not accumulate the energy while dissipating the energy. A detailed schematic of the antenna assembly 102 may be explained with respect to FIG. 3.

FIG. 3 illustrates a detailed schematic of the antenna assembly 102, according to an example of the present subject matter. As mentioned before, the radiation body 202 include the transceiver portion 204 and the non-transceiver portion 206. Further, the radiation body 202 may be designed to send and receive the wireless signal of a predefined wavelength and frequency. In an example, the radiation body 202 may be designed to send and receive Wi-Fi signals or cellular signals operating in 4G or 5G network. For instance, a length of the radiation body 202 that may be needed to transmit the wireless signal of wavelength ‘λ’ may be governed by the equation:

Length of radiation body=an integral multiple of λ/4

Further, the radiation body 202 may be coupled to the wireless unit (not shown) of the user equipment 100 (shown in FIG. 1) and may send an electronic signal to the wireless unit in response to sending and receiving the wireless signal. For instance, the radiation body may receive a wireless signal and send the wireless signal to the wireless unit in the form of the electronic signal. Moreover, the radiation body 202 may also receive electronic signal from the wireless unit and may convert them to the wireless signal for transmission.

According to an example, the non-transceiver portion 206 of the radiation body 202 may include a short end 302 that may be positioned at any point along a length of the non-transceiver portion 206, such that the short end 302 is coupled to the ground plane 210 through the SAR correction element 208. In another example, the short end 302 may be completely replaced by the SAR correction element 208. As mentioned before, the SAR correction element 208 is designed such that the SAR correction element does not accumulate the energy while dissipating the energy. Moreover, the SAR correction element 208 is designed in such a way that the SAR correction element 208 matches the resonance characteristics of the radiation body 202. In the illustrated example, the SAR correction element 208 can be an inductive IC and when connected to the short end 302; may dissipate the near-field energy present at and around the short end 302 to the ground plane 210. In addition, the inductive IC may match an inductive characteristic of the radiation body 202. As a result, the SAR correction element 208 may facilitate in maintaining the transmission range of the radiation body 202.

According to another example, the non-transceiver portion 206 may also include an open end 304 that may be formed as an overhang of the non-transceiver portion 206 with respect to the ground plane 210. Further, the SAR correction element 208 may electrically couple the open end 304 to the ground plane 210, such that the SAR correction element 208 may dissipate the energy, present at the open end 302, to the ground plane 210. In the illustrated example, the SAR correction element 208 can be a capacitive IC that may dissipate the energy without accumulating the energy while dissipating the energy. Moreover, the capacitive IC may match an capacitive characteristic of the antenna assembly thereby maintaining the transmission range of the radiation body 202.

According to an example, the antenna assembly 102 may also include a feeding structure 306 that may electrically couple the transceiver portion 204 to the ground plane 210. In addition, the antenna assembly 102 may include connectors (not shown) that may allow the cables to connect the wireless unit of the user equipment 100 (shown in FIG. 1) to the radiation body 202.

In operation, the transceiver portion 204 may communicate the electronic signals with the wireless unit. In one example, the radiation body 202 may receive electronic signal from the wireless unit. For instance, once the electronic signal is received by the radiation body 202, the transceiver portion 204 may convert the electronic signal into the wireless signal. Further, as the transceiver portion 204 converts the electronic signal into the wireless signal, the near field energy is generated and gets accumulated on the radiation body 202 due to conversion of the electronic signal into the wireless signal. Further, this near field energy is channelized to the ground plane 210 by the SAR correction element 208. In one example, in case the SAR correction element 208 is the inductive IC, the SAR correction element 208 can be connected to the non-transceiver portion 206 at any point along the length of the non-transceiver portion 206 other than at the open end 304 to dissipate the near-field energy to the ground plane 210 while matching the inductive characteristic to the radiation body 202.

Alternatively, if the SAR correction element 208 is a capacitive IC, the SAR correction element 208 is coupled to the open end 304 to dissipate the near-field energy at the open end 304 to the ground plane 210 while matching the capacitive characteristic to the radiation body 202 thereby matching the resonance characteristic of the radiation body 202. In either case, since the SAR correction element 208 is designed to not to accumulate the near-field energy while dissipating the near-field energy, the SAR value of the antenna assembly 102 is not increased. Moreover, as mentioned before, the SAR correction element 208 is designed in a way that the SAR correction element 208 does not generate or radiate the near-field energy while the radiation body 202 transmits or receives the wireless signal.

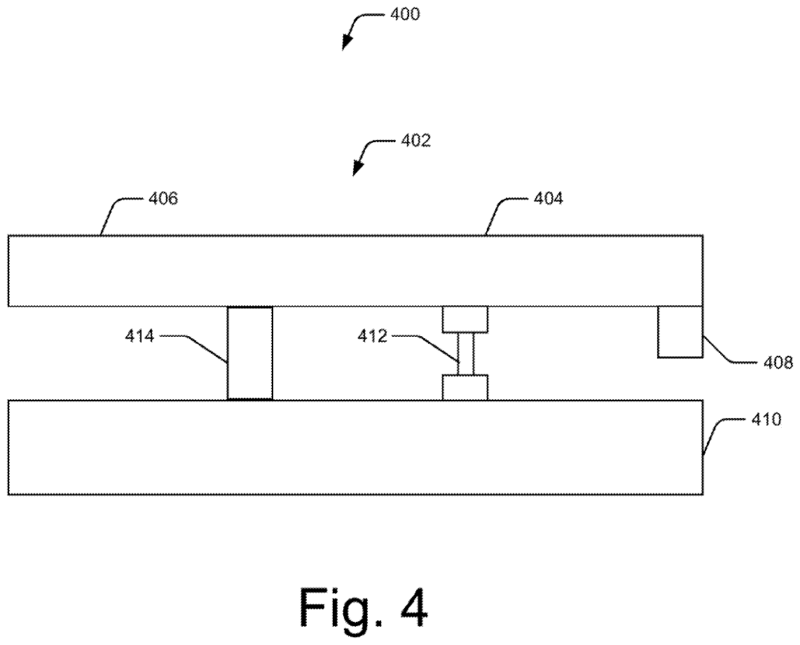

FIG. 4 illustrates an example of an antenna assembly 400, according to an example of the present subject matter. The antenna assembly 400 may include a radiation body 402 that may be similar to the radiation body 202 of the antenna assembly 102. The radiation body 402 may include a non-transceiver portion 404 and transceiver portion 406, such that the transceiver portion 406 may send and receive a wireless signal. In one example, the radiation body 202 may further include an open end 408 that may be formed as an overhang of the non-transceiver portion 404 with respect to a ground plane 410 of the antenna assembly 400. In one instance, the open end 408 may match an capacitive characteristic to the radiation body 402.

According to an example, the antenna assembly 400 may include an inductive SAR correction element 412 that may be coupled to the non-transceiver portion 404 and the ground plane 410. During the operation of the antenna assembly 400, the inductive SAR correction element 412 may dissipate the energy, generated during to transmission and reception of wireless signal, present at the non-transceiver portion 404. Moreover, while dissipating the energy, the inductive SAR correction element 412 does not accumulate the energy thereby preventing an increase in SAR value while dissipating the energy. Further, as mentioned before, the inductive SAR correction element 412 may match an inductive characteristic of the radiation body 202 so that the inductive SAR correction element 412, in combination with the open end 408 may match the resonance characteristic to the radiation body 402 thereby maintaining the transmission range of the radiation body 402. According to an example, the antenna assembly 400 may also include additional components, such as a feeding structure 414 that may couple the transceiver portion 406 to the ground plane 410,

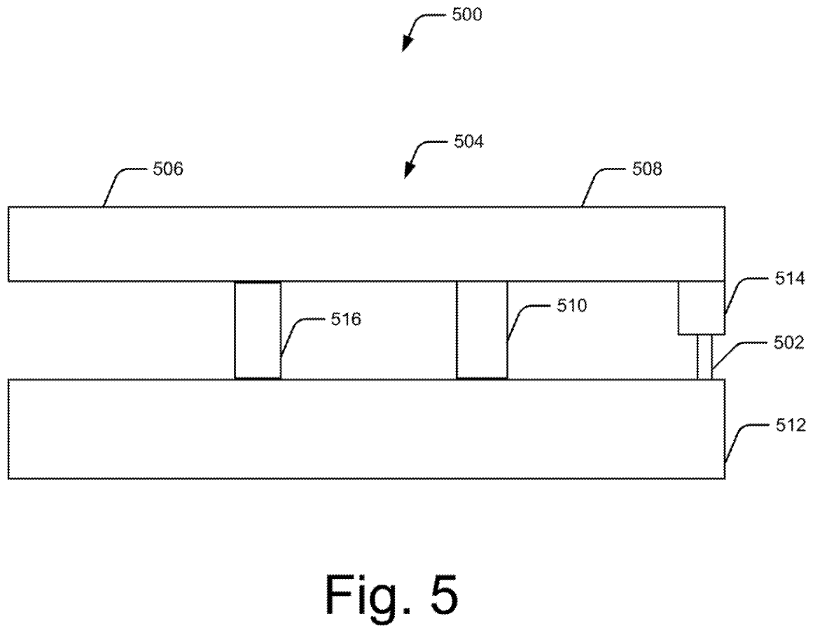

FIG. 5 illustrates another example of the antenna assembly 500, according to an example of the present subject matter. Unlike the antenna assembly 400, the antenna assembly 500 may include a capacitive SAR correction element 502. Other than that, other components of the antenna assembly 500 are similar to the antenna assembly 400. For instance, the antenna assembly 500 may include a radiation body 504 that may be similar to the radiation body 402 of the antenna assembly 400 or the radiation body 202 of the antenna assembly 102. Further, the radiation body 504 may include a transceiver portion 506 and non-transceiver portion 508, such that the transceiver portion 506 may send and receive the wireless signal. The radiation body 504 may also include a short end 510 that may couple the non-transceiver portion 508 to a ground plane 512. In addition, the radiation body 504 may include an open end 514 that may be formed as an overhang of the non-transceiver portion 508 with respect to the ground plane 512.

In one example, the capacitive SAR correction element 502 may be coupled to the open end 514 and the ground plane 512 such that the capacitive SAR correction element 502 dissipates the energy from the non-transceiver portion 508 to the ground plane 512. Further, the capacitive SAR correction element 502 may not accumulate the energy while dissipating the energy thereby preventing the increase in SAR value while dissipating the energy. The antenna assembly 500 may also include a feeding structure 516 that couples the transceiver portion 506 to the ground plane 512 in same manner as the feeding structure 306 of the antenna assembly 102. Further, the operation of the antenna assembly 500 may be similar to the antenna assembly 102 and the capacitive SAR correction element 502 may operate in a same way that h SAR correction element as explained with respect to FIG. 3.

Although aspects for methods and systems for reducing the SAR value have been described in a language specific to structural features and/or methods, the present subject matter is not necessarily limited to the specific features or methods described. Rather, the specific features and methods are disclosed as examples for reducing the SAR value.

1. An antenna assembly comprising:
a radiation body including a transceiver portion and a non-transceiver portion, wherein the transceiver portion sends and receives a wireless signal; and
a SAR correction element operably coupled to the non-transceiver portion of the radiation body, wherein the SAR correction element couples the radiation body to a ground plane at the non-transceiver portion to discharge energy to the ground plane without accumulating the energy therein.

2. The antenna assembly as claimed in claim 1, wherein the SAR correction element matches a resonance characteristic of the radiation body.

3. The antenna assembly as claimed in claim 1, wherein the SAR correction element is a reactive integrated circuit (ICs) and wherein the reactive IC is one of inductive IC and a capacitive IC.

4. The antenna assembly as claimed in claim 1, wherein the non-transceiver portion comprises a short end, and wherein the SAR correction element couples the short end to the ground plane.

5. The antenna assembly as claimed in claim 1, wherein the non-transceiver portion comprises an open end formed as an overhang of the non-transceiver portion with respect to the ground plane, and wherein the SAR correction element couples the open end to the ground plane.

6. The antenna assembly as claimed in claim 3, wherein the reactive IC is made from one of a multi-layer ceramic capacitor, a multi-layer inductor, a switch, and a diode.

7. The antenna assembly as claimed in claim 1 further comprising, a feeding structure to couple the transceiver portion to the ground plane.

8. An antenna assembly comprising:
a radiation body including a transceiver portion and a non-transceiver portion, wherein the transceiver portion sends and receives a wireless signal, the radiation body further comprising;
an open end formed as an overhang of the non-transceiver portion with respect to the ground plane; and
an inductive SAR correction element electrically coupled between the ground plane and the non-transceiver portion to discharge energy from the non-transceiver portion to the ground plane without accumulating the energy therein.

9. The antenna assembly as claimed in claim 8, wherein the inductive SAR correction element is an inductive integrated circuit (ICs).

10. The antenna assembly as claimed in claim 9, wherein the inductive SAR correction includes a multi-layer inductor.

11. The antenna assembly as claimed in claim 8 further comprising a feeding structure to couple the transceiver portion to the ground plane.

12. An antenna assembly comprising:
a radiation body including a transceiver portion and a non-transceiver portion, wherein the transceiver portion sends and receives a wireless signal, the radiation body further comprising
a short end to couple the non-transceiver portion of the radiation body to a ground plane;
an open end coupled formed as an overhang of the non-transceiver portion with respect to the ground plane; and
a capacitive SAR correction element to electrically couple between the ground plane and the open end to discharge an energy to the ground plane without accumulating the energy therein.

13. The antenna assembly as claimed in claim 12, wherein the capacitive SAR correction element is a capacitive integrated circuit (ICs).

14. The antenna assembly as claimed in claim 13, wherein the capacitive IC include a multi-layer ceramic capacitor.

15. The antenna assembly as claimed in claim 11 further comprising a feeding structure to couple the transceiver portion to the ground plane.
